(19) United States
(12) Patent Application Publication
(10) Pub. No.: US 2026/0138878 A1
(43) Pub. Date: May 21, 2026

(54) AMMONIA SYNTHESIS PLANT AND METHOD

(71) Applicant: Nuovo Pignone Tecnologie - S.r.l., Florence (IT)

(72) Inventors: Francesco CANGIOLI, Florence, Firenze (IT); Angelo GRIMALDI, Florence, Firenze (IT); Tiziano PELLEGRINI, Florence, Firenze (IT); Giulia MEAZZINI, Florence, Firenze (IT); Alberto GUGLIELMO, Florence, Firenze (IT)

(21) Appl. No.: 18/705,848

(22) PCT Filed: Oct. 27, 2022
(86) PCT No.: PCT/EP2022/025487

§ 371 Date: Apr. 29, 2024

(30) Foreign Application Priority Data
Nov. 4, 2021 (IT) 102021000028049

(51) Int. Cl. C01C 1/04; C25B 1/04; C25B 15/08

(52) U.S. Cl. CPC C01C 1/0405; C25B 15/081; C25B 1/04

(57) ABSTRACT

The ammonia production system comprises a hydrogen source and a hydrogen compression unit, adapted to compress hydrogen from the hydrogen source. The system further comprises a nitrogen source and a syngas compressor, adapted to receive nitrogen from the nitrogen source and hydrogen from the hydrogen compression unit, and further adapted to compress a syngas including a mixture of hydrogen and nitrogen and deliver the compressed gas mixture to an ammonia synthesis module. The nitrogen source is fluidly coupled to the hydrogen compression unit, such that in use the hydrogen compression unit compresses a blend containing hydrogen and nitrogen.

### TECHNICAL FIELD

The present disclosure relates to ammonia synthesis plants and methods. Specifically, disclosed herein are novel compression train arrangements for ammonia synthesis systems and relevant methods.

### BACKGROUND ART

Ammonia (NH₃) is a gas with a high solubility in water, which is often used in an aqueous solution. Ammonia is used in several industrial applications, among others for the production of nitric acid, urea and other ammonia salts, such as nitrates, phosphates, and the like. Ammonia derivatives are widely used in agriculture. Around 80% of the ammonia production is used for the manufacturing of fertilizers.

Commonly, ammonia is produced by synthesis of nitrogen and hydrogen according to the following exothermic reaction (i.e. a reaction which releases heat):

$${N}_{2} + 3 {H}_{2} ↔ 2 {NH}_{3} + Δ H$$

wherein ΔH is heat released by the reaction.

According to a widely used method, ammonia production usually starts from a feed gas, which provides a source of hydrogen, such as methane, for instance. Nitrogen is obtained from air.

Alternative methods for ammonia synthesis use hydrogen obtained by electrolysis. Recently, in an attempt to reduce production of green house gases and avoid use of hydrocarbons, so-called green ammonia production processes and systems have been intensively investigated. Green ammonia production is where the process of making ammonia is 100% renewable and carbon-free. One way of making green ammonia is by using nitrogen separated from air and hydrogen from water electrolysis powered by renewable energy resources. Nitrogen and hydrogen are then fed into a Haber process (also known as Haber-Bosch process), where hydrogen and nitrogen are reacted together at high temperatures and pressures to produce ammonia.

While the Haber process is usually conducted under high-pressure and high-temperature conditions, which in turn require high energy, more recently synthesis processes under lower temperature conditions have been investigated, using suitable catalysts promoting the synthesis reaction.

Irrespective of the synthesis process used, one critical aspect of ammonia production using hydrogen produced by electrolysis at ambient pressure is the need for compressing the hydrogen at the high pressure required for the synthesis reaction.

Compressing gas having a low molecular weight (Mw) may be challenging, as the lower the molecular weight of the gas, the higher the rotational speed of the compressor impellers and/or the number of compressor stages and compressor casings needed to achieve the desired compression ratio. Long compressor trains including a large number of compressor stages possibly divided into several compressor casings pose challenging problems to the designers in terms of rotor-dynamic issues, among others.

Hydrogen is the gas having the lowest molecular weight and compression thereof is therefore particularly demanding in terms of compressor performances.

Even though catalysts may reduce the temperature at which the reaction is conducted, high pressure of the gases involved in the synthesis reaction is needed to improve the efficiency of the synthesis process in terms of ammonia yield.

The need to compress hydrogen from ambient pressure, at which it is produced by electrolysis, up to the pressures needed for an efficient ammonia synthesis reaction makes the design of hydrogen compressors particularly demanding, both in terms of number of compressor stages, as well as in terms of rotational speed thereof, when dynamic compressors, such as centrifugal compressors, are used.

It would therefore be beneficial to simplify the structure, manufacture and control of hydrogen compressors in an ammonia production system, specifically in a green ammonia synthesis system.

### SUMMARY

According to one aspect, disclosed herein is an ammonia production system, which includes a hydrogen source and a hydrogen compression unit, adapted to compress hydrogen from the hydrogen source. The system further includes a nitrogen source. A syngas compressor is adapted to receive nitrogen from the nitrogen source and hydrogen from the hydrogen compression unit, and further adapted to compress a syngas including a mixture of hydrogen and nitrogen for delivery to an ammonia synthesis module, fluidly coupled to the syngas compressor. The nitrogen source is fluidly coupled to the hydrogen compression unit, such that in use the hydrogen compression unit compresses a blend containing hydrogen and nitrogen. The molecular weight of the gas blend processed by the hydrogen compression unit is thus higher with respect to the molecular weight of pure hydrogen, improving the compression process and simplifying the hydrogen compression unit.

The hydrogen compression unit includes at least one dynamic compressor, for instance, a centrifugal compressor. In embodiments, the hydrogen compression unit includes a plurality of dynamic compressors in series to achieve the desired compression ratio.

According to a further aspect, a method for producing ammonia from hydrogen and nitrogen is disclosed. The method comprises the step of delivering a nitrogen flow, at a syngas suction pressure, to a suction side of a syngas compressor. The method further includes the step of delivering a hydrogen flow at a hydrogen inlet pressure, lower than the syngas suction pressure, to a suction side of a hydrogen compression unit. A further step includes boosting the pressure of the hydrogen flow from the hydrogen inlet pressure to the syngas suction pressure in the hydrogen compression unit and delivering the compressed hydrogen to the syngas compressor. Additionally, the method also includes the step of delivering pressurized syngas from the syngas compressor to an ammonia synthesis module and producing ammonia from the compressed syngas. According to embodiments disclosed herein, the method further comprises the step of adding nitrogen to the hydrogen in the hydrogen compression unit to increase the molecular weight of the gas processed by the hydrogen compression unit.

### BRIEF DESCRIPTION OF THE DRAWINGS

Reference is now made briefly to the accompanying drawings, in which:

FIG. 1 is a schematic of a system according to the present disclosure in an embodiment;

FIG. 2 is a schematic of a system according to the present disclosure in a further embodiment;

FIG. 3 is a schematic of a system according to the present disclosure in a further embodiment;

FIG. 4 is a schematic of a system according to the present disclosure in a further embodiment;

FIG. 5 is a schematic of a system according to the present disclosure in a further embodiment;

FIG. 6 is a schematic of a system according to the present disclosure in a further embodiment;

FIG. 7 is a schematic of a system of the present disclosure in a yet further embodiment; and

FIG. 8 is a flowchart summarizing a method according to the present disclosure.

### DETAILED DESCRIPTION

In general terms, the disclosed herein is a system for ammonia synthesis, including novel features adapted to simplify the structure or the design of the hydrogen compression unit.

In a nutshell, the system is configured such that an amount of nitrogen is added to a flow of low-pressure hydrogen prior to achieving the final hydrogen pressure required at the suction side of the syngas compressor, where partially compressed hydrogen is mixed with nitrogen from the nitrogen source. In some embodiments, prior to blending with hydrogen in the hydrogen compression unit, the nitrogen flow is depressurized.

The blend of hydrogen and nitrogen processed by the hydrogen compression unit has a molecular weight which is higher than the molecular weight of pure hydrogen. If at least part of the hydrogen compression is performed with the hydrogen being mixed to nitrogen, the hydrogen compressor stages can be reduced and/or the rotational speed thereof can be lower than the rotational speed of the hydrogen compressors of the current art. This makes the design of the compressors less demanding and may reduce the overall dimension of the hydrogen compression unit.

Since nitrogen and hydrogen shall be mixed to form a syngas for subsequent delivery to the ammonia synthesis module, separation of nitrogen and hydrogen after compression is not required.

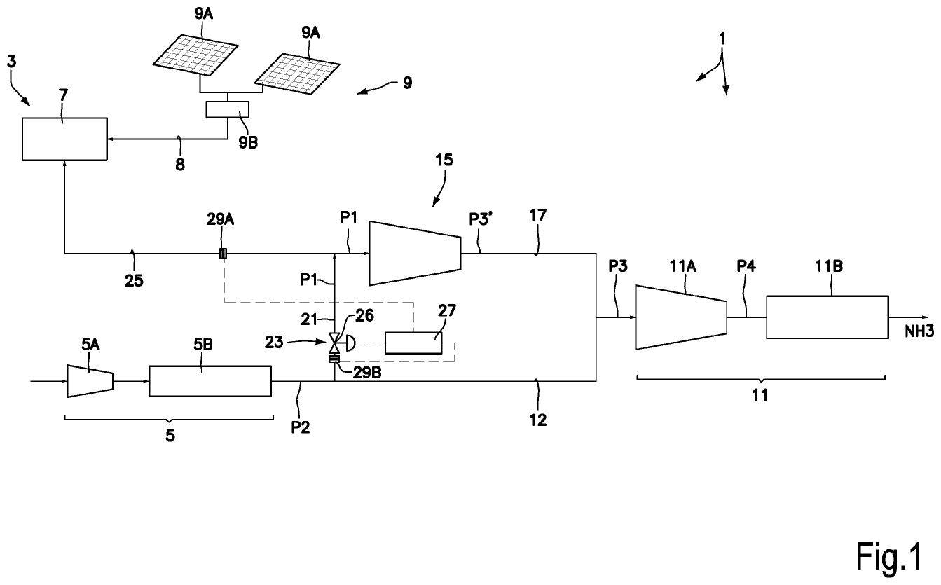

Turning now to the drawings, FIG. 1 illustrates a schematic of an ammonia production system 1 according to the present disclosure in one embodiment. The ammonia production system 1 comprises a hydrogen source 3 and a nitrogen source 5. In the exemplary embodiment of FIG. 1, the hydrogen source 3 may include an electrolyzer 7. The electrolyzer 7 can be powered with electric energy from an electric power distribution grid 8. In some embodiments, the electric energy can at least partly be provided by one or more renewable energy resources. By way of non-limiting example, in the schematic of FIG. 1 the renewable energy is solar energy. Energy from the renewable resource can be collected and converted into electric energy by an electric converter 9. In FIG. 1 the electric converter 9 includes photovoltaic panels 9A and a solar inverter 9B electrically coupled to the photovoltaic panels 9A and to the electric power distribution grid 8.

In other embodiments, not shown, other renewable energy resources can be used instead of, or in addition to, solar energy. For instance, wind, geothermal energy, wave and tidal energy, or the like can be used.

In some embodiments, the electric power distribution grid 8 can be connected to a public power distribution grid, which is adapted to supply electric power in case of shortage of power from the renewable energy resource and/or to receive electric power from the electric converter 9, if the electric power obtained from the renewable energy resource exceeds the power needs of the electrolyzer 7. Alternatively, or in combination excess electric power from the electric converter 9 can be used by other modules of the system 1 and/or stored in a suitable storage unit, not shown.

The nitrogen source 5 may include any arrangement adapted to provide nitrogen, for instance by separation from ambient air. In the embodiment of FIG. 1, the nitrogen source 5 includes an air compressor 5A and a nitrogen separation module 5B. The nitrogen separation module 5B may include a membrane separator, a fractioning system, for instance, or any other device adapted to separate nitrogen from the other air components, specifically oxygen and carbon dioxide.

The ammonia production system 1 further comprises an ammonia synthesis unit globally labeled 11. The ammonia synthesis unit 11 may include a compressor 11A and an ammonia synthesis module 11B. While a single compressor 11A is shown for the sake of simplification in the schematic of FIG. 1, it shall be understood that the compressor 11A may in turn include a single compressor or a plurality of compressors, typically centrifugal compressors, arranged in parallel and/or in series, for example along the shaft line of a compressor train.

The ammonia synthesis module 11B may include any arrangement adapted to synthesize ammonia from a blend or mixture of hydrogen and nitrogen in gaseous form, delivered to the ammonia synthesis module 11B at a suitable pressure by the compressor 11A. In the present specification the compressor 11A will be referred to as syngas compressor, as it is adapted to compress the gas mixture containing nitrogen and hydrogen, which is required for the ammonia synthesis.

The hydrogen is delivered by the hydrogen source 3 at a low hydrogen pressure P1, for instance at around ambient pressure. The nitrogen source 5 delivers nitrogen at a low nitrogen pressure P2 toward the ammonia synthesis unit 11 through a nitrogen delivery line 12. The low nitrogen pressure P2 is higher than the low hydrogen pressure P1, due to the nature of the separation process performed by the nitrogen separation module 5B, which is fed with pressurized air by the air compressor 5A.

The nitrogen from the nitrogen source 5 flows through a main nitrogen delivery duct 12 to a suction side of the syngas compressor 11A. At the suction side of the syngas compressor 11A the nitrogen is at a syngas suction pressure P3. The syngas suction pressure P3 is substantially equal to or slightly lower than the low nitrogen pressure P2, due to head losses along the main nitrogen delivery duct 12.

The ammonia production system 1 further comprises a hydrogen compression unit 15, the inlet whereof is fluidly coupled to the hydrogen source 3, and the outlet whereof is fluidly coupled to the suction side of the syngas compressor 11A. Since the low hydrogen pressure P1 is substantially lower than the syngas suction pressure P3, the hydrogen from the hydrogen source 3 is pressurized in the hydrogen compression unit 15, from the low hydrogen pressure P1 to the syngas suction pressure P3, or to a slightly higher pressure P3′, to take account of the head losses along the connection duct 17, which fluidly couples the delivery side of the hydrogen compression unit 15 to the syngas compressor 11A.

In the schematic of FIG. 1, the hydrogen compression unit 15 is represented as a single compressor. It should, however, be understood that in general terms the hydrogen compression unit 15 may include one or more compressors, typically centrifugal compressors, which are usually arranged in series, and which may form a single compressor train with a plurality of compressors arranged along a common shaft line driven by a driver, not shown. Each compressor of the hydrogen compression unit 15 may in turn include a plurality of compressor stages.

The gas delivered by the hydrogen compression unit 15 and by the nitrogen source 5 flow together in the syngas compressor 11A, which thus processes a blend of hydrogen and nitrogen, boosting the pressure of the gas mixture from the syngas suction pressure P3 to the final pressure P4 required for the synthesis reaction performed in the ammonia synthesis module 11B.

In order to increase the molecular weight of the gas processed by the hydrogen compression unit 15 and make the design of the hydrogen compressors less challenging, for instance in order to reduce the rotational speed or the number of compressor impellers needed to boost the hydrogen pressure from the low hydrogen pressure P1 to the syngas suction pressure P3, a certain amount of nitrogen is added to the hydrogen prior to or during compression in the hydrogen compression unit 15. Nitrogen is provided by the nitrogen source 5.

In the embodiment of FIG. 1, the major part of nitrogen provided by the nitrogen source 5 is delivered through the main nitrogen delivery duct 12 to the suction side of the syngas compressor 11A. A secondary nitrogen flow is diverted from the main nitrogen delivery duct 12 through a secondary nitrogen delivery line 21, which fluidly connects the nitrogen source 5 to the hydrogen compression unit 15. In the embodiment of FIG. 1, the secondary nitrogen delivery line 21 is connected to a hydrogen delivery line 25 upstream of the inlet of the hydrogen compression unit 15. Thus, the nitrogen supplied though the secondary nitrogen delivery line 21 must be depressurized at the low hydrogen pressure P1 prior to be blended with the hydrogen from the hydrogen source 3.

Since the low nitrogen pressure P2 in the main nitrogen delivery duct 12 is usually higher than the low hydrogen pressure P1 at the inlet side of the hydrogen compression unit 15, a pressure reduction device 23 is positioned along the secondary nitrogen delivery line 21.

In some embodiments, the pressure reduction device 23 comprises a throttling valve 26. As used herein the term “throttling valve” includes any valve adapted to reduce the pressure of the gas flowing therethrough.

In the embodiment of FIG. 1, the pressure reduction device 23 is controlled to adjust the nitrogen pressure and flowrate. A control unit 27 can be functionally connected to the pressure reduction device 23 for such purpose.

In some embodiments, the control unit 27 is further functionally connected to a flowrate detection arrangement. In the embodiment of FIG. 1, the flowrate detection arrangement is adapted to detect the flowrate of the hydrogen along the hydrogen delivery line 25 and further to detect the flowrate of the nitrogen in the secondary nitrogen delivery line 21. Schematically, the flowrate detection arrangement includes a hydrogen flowmeter 29A in the hydrogen delivery line 25 and a nitrogen flowmeter 29B in the secondary nitrogen delivery line 21, upstream of the pressure reduction device 23. In general terms, the flowrate detection arrangement is adapted to detect a mass flow rate. In some embodiments, this can be obtained, e.g., using an orifice in combination with temperature and pressure measurements.

Based on the flowmeters signals, the control unit 27 is adapted to adjust the percentage of nitrogen blended with the hydrogen delivered by the hydrogen source 3. The higher the amount of nitrogen added to the hydrogen flow, the higher the molecular weight of the gaseous mixture processed by the hydrogen compression unit 15. Since a blend of gases at higher molecular weight is processed easier than pure hydrogen in the hydrogen compression unit 15, increasing the molar percentage of nitrogen in the gaseous mixture processed by the hydrogen compression unit 15 results in a reduction of the tip speed of the compressor impellers in the hydrogen compression unit 15 and/or in a reduction of the number of impellers, and therefore possibly a reduction of the number of compressors of the hydrogen compression unit 15.

The control unit 27 can be adapted to adjust the pressure reduction device 23 when the flowrate processed by the syngas compressor 11A changes. The control unit 27 can for instance be adapted to maintain the ratio between nitrogen and hydrogen flowrates within a predetermined range when the total flowrate processed by the syngas compressor changes over time.

As noted above, the nitrogen pressure in the secondary nitrogen delivery line 21 must be reduced from the pressure value P2 (low nitrogen pressure P2) to pressure P1 (low hydrogen pressure P1) that is lower than P2. The resulting hydrogen and nitrogen mixture must then be pressurized again at pressure P3′, which is substantially equal to P2. Therefore, nitrogen expansion in the pressure reduction device 23 causes some degree of energy loss, that is directly proportional to the percentage of nitrogen blended in the hydrogen flow.

A compromise shall therefore be achieved, between the cost in terms of energy and power losses and the advantages in terms of reduction of the hydrogen compression unit speed and/or number of impellers and stages thereof.

As an example, but without limitation, the nitrogen molar percentage in the gaseous flow processed by the hydrogen compression unit 15 may vary from 2% to 20% and preferably from 4% to 15%. More preferably, the molar percentage of nitrogen in the hydrogen-nitrogen blend can range between 4% and 10%.

In the embodiment of FIG. 1, the secondary nitrogen flow delivered through the secondary nitrogen delivery line 21 is fed upstream of the hydrogen compression unit 15, such that the nitrogen pressure must be reduced from the low nitrogen pressure P2 to the low hydrogen pressure P1. This approach maximizes the pressure loss, and thus the amount of additional power required to re-pressurize the percentage of secondary nitrogen flow, which is delivered through the secondary nitrogen delivery line 21. However, the beneficial effect of nitrogen and hydrogen blending, in terms of easier compression in the hydrogen compression unit 15, is maximized.

In other embodiments, a compromise between energy loss and advantages in terms of hydrogen-nitrogen blend compression can be obtained by adding the secondary nitrogen flow in an intermediate stage of the hydrogen compression. In such case, the advantage of molecular weight increase is reduced, but the loss of power caused by the need to expand part of the nitrogen flow is also reduced.

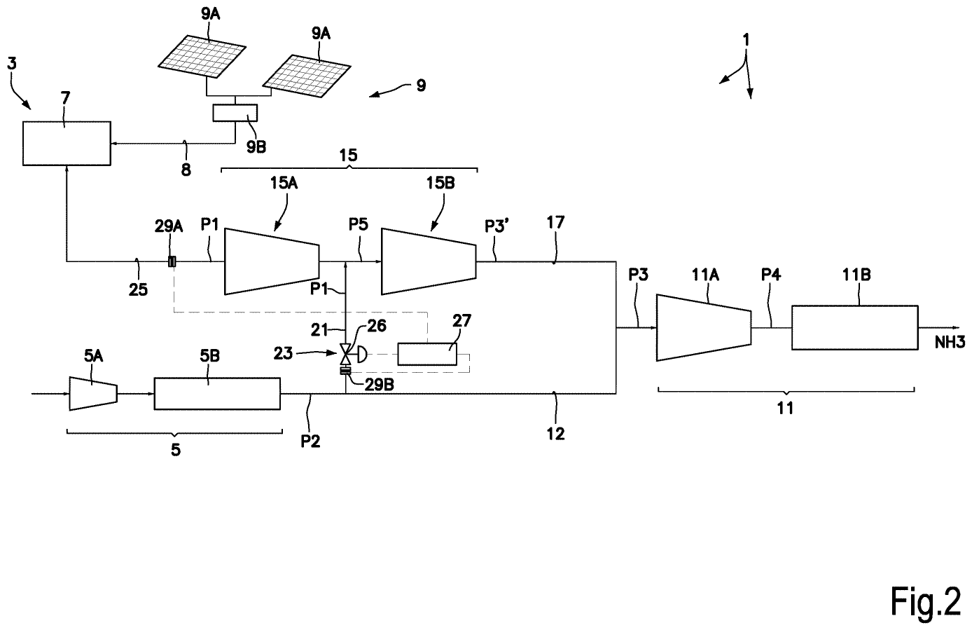

With continuing reference to FIG. 1, FIG. 2 illustrates an embodiment where nitrogen is added to the hydrogen flow once this latter has been partly compressed. The same numbers designate the same or equivalent components already shown in FIG. 1 and described above. These components and their function will not be described again.

The embodiment of FIG. 2 differs from the embodiment of FIG. 1 mainly in that hydrogen compression is split in two phases and nitrogen is added between the first and second compression phase to the hydrogen flow.

In the embodiment of FIG. 2, the hydrogen compression unit 15 is shown as including two hydrogen compressors 15A and 15B. The two hydrogen compressors 15A and 15B are arranged in series, the first hydrogen compressor 15A being arranged upstream of the second hydrogen compressor 15B with respect to the direction of the hydrogen flow through the hydrogen compression unit 15. The suction side of the first hydrogen compressor 15A receives hydrogen from the hydrogen source 3 at low hydrogen pressure P1. Hydrogen at an intermediate hydrogen pressure P5 is delivered from the delivery side of the first hydrogen compressor 15A to the suction side of the second hydrogen compressor 15B. The hydrogen pressure is boosted by the second hydrogen compressor 15B from the intermediate hydrogen pressure P5 to the syngas pressure P3 or to a slightly higher pressure P3′.

The secondary nitrogen delivery line 21 is fluidly coupled to the hydrogen compression unit 15 between the delivery side of the first hydrogen compressor 15A and the suction side of the second hydrogen compressor 15B. Thus, the pressure reduction device 23 reduces the nitrogen pressure from the low nitrogen pressure P2 to the intermediate hydrogen pressure P5, which is higher than the low hydrogen pressure P1. A lower power loss is thus required to reach the pressure required in the secondary nitrogen delivery line 21. This is beneficial in terms of reduction of power consumption of the system 1, but reduces the advantages in terms of hydrogen compression, since the molecular weight of the gaseous flow processed in the hydrogen compression unit 15 is increased only in the second hydrogen compressor 15B, but not in the first hydrogen compressor 15A.

In further embodiments, the enthalpic drop of the secondary nitrogen flow through the pressure reduction device 23 can be at least partly recovered to produce useful power. For this purpose, the pressure reduction device 23 can comprise at least one expander instead of the throttling valve 26, or in combination therewith.

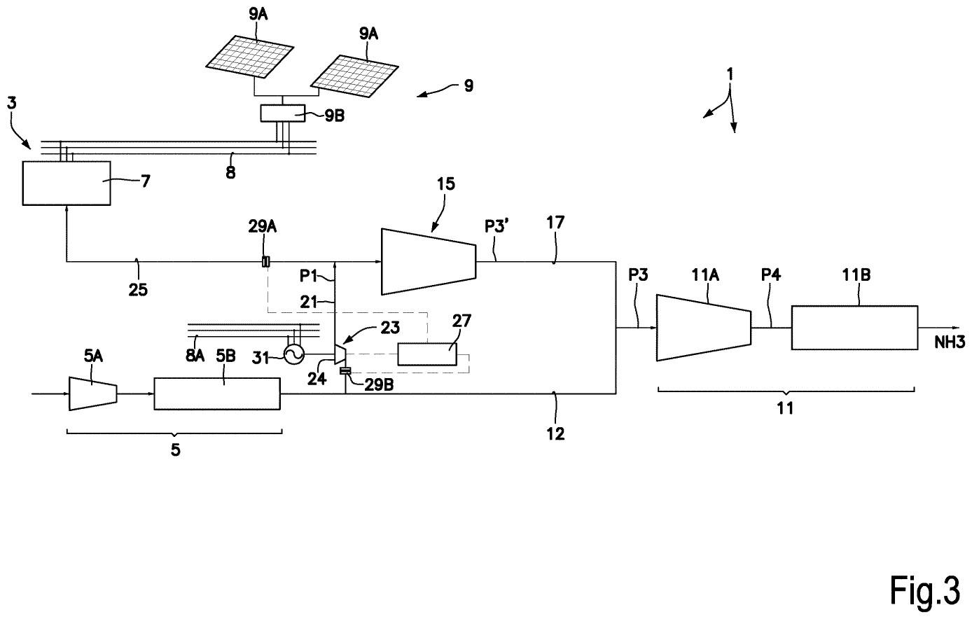

With continuing reference to FIGS. 1 and 2, FIG. 3 illustrates an embodiment similar to FIG. 1, wherein the throttling valve 26 is replaced by an expander 24. Components of the system shown in FIG. 3 that have already been disclosed in connection with FIG. 1 are labeled with the same reference numbers and will not be described again.

The main difference between the embodiment of FIG. 3 and the embodiment of FIG. 1 consists in that the pressure of the nitrogen from the nitrogen source 5 is reduced by expansion in the expander 24 of the pressure reduction device 23, rather than in a throttling valve. In the embodiment of FIG. 3, the expander 24 is drivingly coupled to an electric generator 31. The enthalpy drop of the secondary nitrogen flow in the expander 24 is therefore at least partly converted into electric power by the electric generator 31. The electric power is delivered to an electric power distribution grid, labeled with reference number 8A. The electric power distribution grid 8A can be part of the electric power distribution grid 8, or can be electrically connected thereto. Thus, power recovered by the expander 24 from the nitrogen expansion can be used to produce hydrogen. Alternatively, or in combination, the electric power generated by the electric generator 31 can be used to power other components of the system 1, for instance, the electric motors driving one or more of the compressors in the system 1. In further embodiments, the expander 24 may be drivingly coupled to the shaft of one or more of the hydrogen compressor, the air compressor and the syngas compressor. In this embodiment, the expander 24 would be used as a mechanical driver (helper) helping the main driver of the respective compressor, thus reducing the external supply power and main driver sizing.

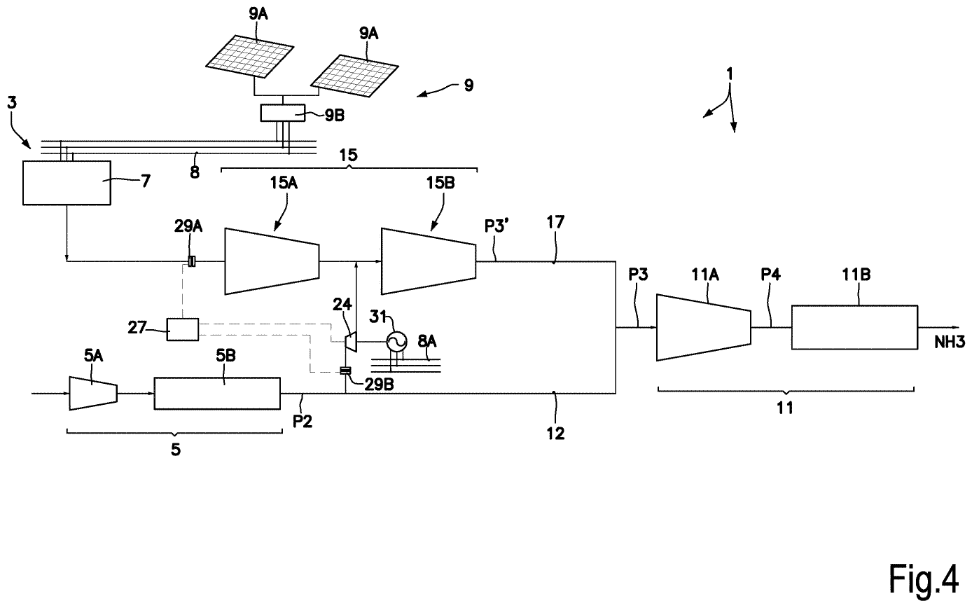

An expander 24 can also be used instead of, or in combination with the throttling valve 26 of the embodiment of FIG. 2, as shown in the embodiment of FIG. 4. Power generated by the expander 24 can be exploited as such or converted into electric power, as outlined above.

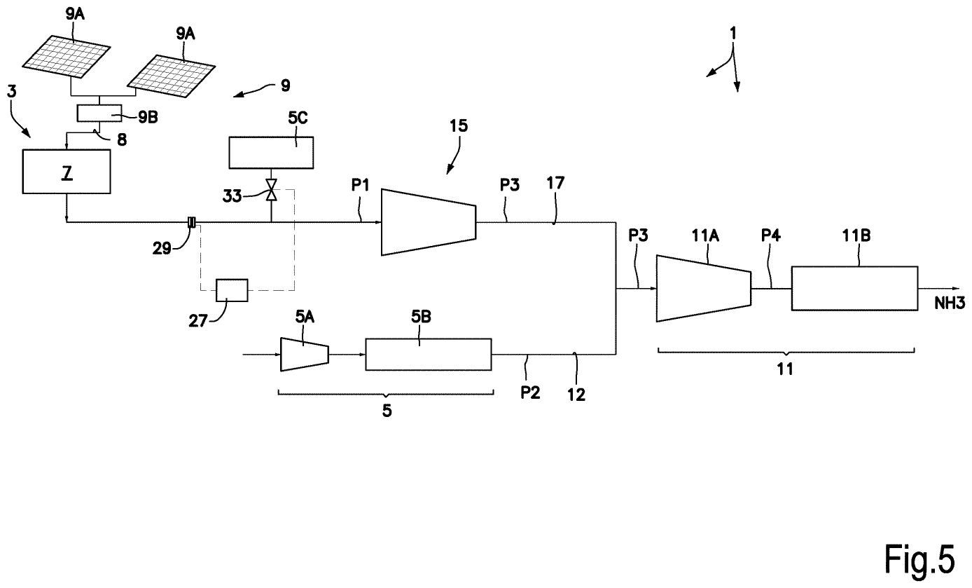

While in currently preferred embodiments the secondary nitrogen flow is diverted from the main nitrogen delivery line 12, the option is not ruled out of diverting the secondary nitrogen flow from an additional nitrogen source component, which is independent from the nitrogen separation module 5B. Such an option is shown in FIG. 5, wherein the same reference numbers used in FIGS. 1 to 4 designate the same or equivalent components, which are not described again. In FIG. 5 the nitrogen source 5 includes an additional nitrogen source 5C, for instance a nitrogen delivery line from a separate plant or system. A duct 32 connects the additional nitrogen source 5C of the nitrogen source 5 to the suction side of the hydrogen compression unit 15. A controlled valve 33 can be arranged along the duct 32 to modulate the amount of nitrogen flow. A flowmeter 29 interfaced with a control unit 27 is further foreseen, the control unit 27 being adapted to control the valve 33.

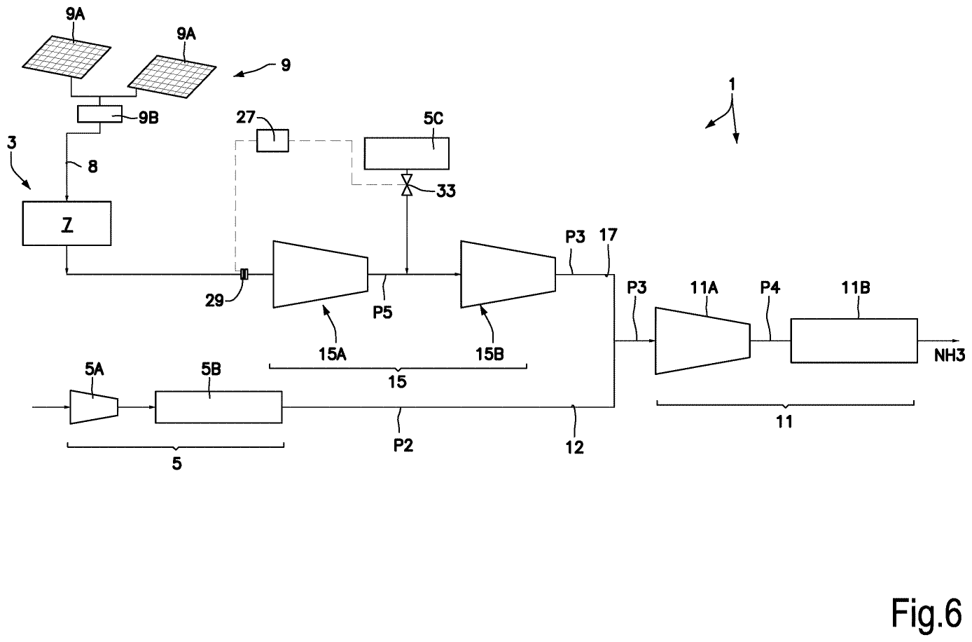

An additional nitrogen source 5C can be envisaged also in an embodiment according to FIG. 2, wherein the secondary nitrogen flow is injected between a first upstream hydrogen compressor and a second downstream hydrogen compressor. This embodiment is shown in FIG. 6, wherein the same reference numbers are used to designate the same or corresponding components already described in connection with FIGS. 2 and 5, and not described again.

In the embodiments described above the secondary nitrogen flow is delivered entirely upstream of the hydrogen compression unit 15 (FIGS. 1, 3 and 5), or entirely between an upstream hydrogen compressor 15A and a downstream hydrogen compressor 15B of the hydrogen compression unit 15. In other embodiments, the secondary nitrogen flow can be split and delivered partly upstream of the hydrogen compression unit 15 and partly in an intermediate position between sequentially arranged hydrogen compressors 15A, 15B. Alternatively, the secondary nitrogen flow can also be split into more than one stream and delivered at different pressure levels in different points of the hydrogen compression unit 15, for instance at the suction side of different compressors or different compressor stages.

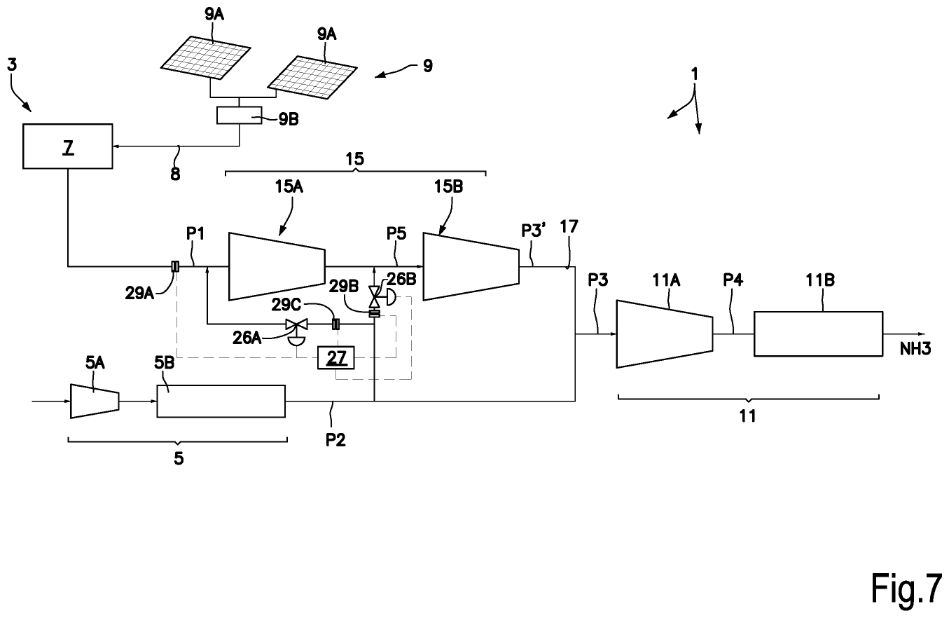

For instance, in FIG. 7, where the same reference numbers are used to designate the same or corresponding components already disclosed in connection with FIGS. 1, 2, 3, 4, 5 and 6, and which will not be described again, the secondary nitrogen flow is diverted from the main nitrogen delivery duct 12 at pressure P2 and is split in a first secondary nitrogen flow delivered at pressure P1 upstream of the hydrogen compression unit 15 and in a second secondary nitrogen flow delivered at pressure P5 between the first hydrogen compressor 15A and the second hydrogen compressor 15B. Two pressure reduction valves, such as two controlled throttling valves 26A and 26B can be interfaced to a control unit 27. Alternatively, one or both throttling valves 26A, 26B can be replaced by expanders. Three flow detection devices 29A, 29B and 29C are used to detect the hydrogen flowrate delivered by the hydrogen source 3 to the hydrogen compression unit 15, as well as the flowrate of the first and second secondary nitrogen flows.

In the above description of some embodiments reference has been made to a first, upstream hydrogen compressor 15A and to a second, downstream hydrogen compressor 15B, wherein a secondary nitrogen flow can be delivered therebetween at intermediate pressure P5. It shall however be understood that the hydrogen compression unit 15 can include more than two sequentially arranged hydrogen compressors 15A, 15B, and that more than just one secondary nitrogen flow can be delivered between more than just one pair of sequentially arranged hydrogen compressors, provided the secondary nitrogen flows are delivered at the correct intermediate pressure.

Moreover, as understood herein, the first and second sequentially arranged hydrogen compressors may also be embodied by two sequentially arranged compressor stages of the same compressor device. For instance, one or more secondary nitrogen flows can be injected as side streams in one or more intermediate positions along one or more multi-stage hydrogen compressors.

Moreover, while some of the above disclosed embodiments provide a secondary nitrogen flow diverted from the main nitrogen flow delivered from the nitrogen separation module 5B, while some other embodiments provide for a secondary nitrogen flow delivered by an additional nitrogen source 5C, other embodiments, not shown, may include both a secondary nitrogen flow diverted from the main nitrogen delivery duct 12 and an additional nitrogen source 5C delivering an additional secondary nitrogen flow, in combination. In such case, the two secondary nitrogen flows can be either combined and fed in the same point of the hydrogen compression unit 15, or can be maintained separate and delivered to different points of the hydrogen compression unit 15 at proper nitrogen pressure.

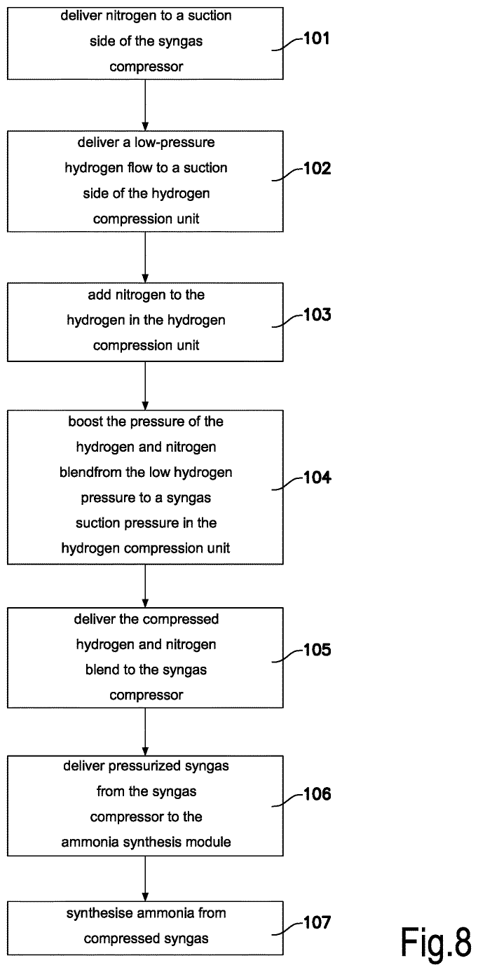

FIG. 8 illustrates a flow chart summarizing the method performed by the ammonia production systems disclosed so far. In summary, the method includes the following. In step 101 nitrogen is delivered to a suction side of the syngas compressor 11A. In step 102 a low-pressure hydrogen flow is delivered to a suction side of the hydrogen compression unit 15. In step 103 nitrogen is added to the hydrogen in the hydrogen compression unit 15, either upstream of the suction side thereof and/or in an intermediate position between the suction side at pressure P1 and the delivery side at pressure P3′. In step 104 the pressure of the hydrogen and nitrogen blend is boosted from the low hydrogen pressure P1 to, or slightly above, a syngas suction pressure P3 in the hydrogen compression unit 15. The compressed hydrogen and nitrogen blend is delivered to the syngas compressor 11A, see step 105. Pressurized syngas from the syngas compressor 11A is delivered to the ammonia synthesis module 11B (step 106) and finally ammonia is synthetized in the ammonia synthesis module 11B from compressed syngas (step 107).

Certain exemplary embodiments have been described to provide an overall understanding of the principles of the structure, function and use of the systems, devices and methods disclosed herein. One or more examples of these embodiments are illustrated in the accompanying drawings. Those skilled in the art will understand that the systems, devices and methods specifically described herein and illustrated in the accompanying drawings are non-limiting exemplary embodiments and that the scope of the present invention is defined solely by the claims. Features described or illustrated in connection with one exemplary embodiment may be combined with the features of other embodiments. Such modifications and variations are intended to be included within the scope of the present invention.

1. An ammonia production system comprising:
a hydrogen source;
a hydrogen compression unit, adapted to compress hydrogen from the hydrogen source;
a nitrogen source;
a syngas compressor, adapted to receive nitrogen from the nitrogen source and hydrogen from the hydrogen compression unit, and further adapted to compress a syngas including a mixture of hydrogen and nitrogen; and
an ammonia synthesis module, fluidly coupled to the syngas compressor;
wherein the nitrogen source is fluidly coupled to the hydrogen compression unit, such that in use the hydrogen compression unit compresses a blend containing hydrogen and nitrogen.

2. The system of claim 1, wherein the hydrogen compression unit comprises an inlet fluidly coupled to the hydrogen source and adapted to receive hydrogen from the hydrogen source, and an outlet fluidly coupled to the syngas compressor; and wherein the nitrogen source is fluidly coupled to the inlet of the hydrogen compression unit.

3. The system of claim 1, wherein the hydrogen compression unit comprises at least a first hydrogen compressor and a second hydrogen compressor arranged in series; and wherein the nitrogen source is fluidly coupled to the hydrogen compression unit between a delivery side of the first hydrogen compressor and a suction side of the second hydrogen compressor.

4. The system of claim 1, comprising a nitrogen delivery line fluidly coupling the nitrogen source to the hydrogen compression unit, and a pressure reduction device along the nitrogen delivery line, between the nitrogen source and the hydrogen compression unit.

5. The system of claim 4, wherein the pressure reduction device comprises a throttling valve.

6. The system of claim 4, wherein the pressure reduction device comprises an expander.

7. The system of claim 6, wherein the expander is drivingly coupled to one of: an electric generator, a compressor.

8. The system of claim 4, wherein the pressure reduction device is controlled by a control unit, functionally coupled to a flowrate detection arrangement.

9. The system of claim 8, wherein the flowrate detection arrangement comprises a hydrogen flowrate detection device adapted to detect a hydrogen flowrate fed to the hydrogen compression unit, and a nitrogen flowrate detection device adapted to detect a nitrogen flowrate fed to the hydrogen compression unit.

10. The system of claim 9, further comprising a control unit functionally coupled to the hydrogen flowrate detection device and to the nitrogen flowrate detection device; wherein the control unit is adapted to control the pressure reduction device to maintain a ratio between nitrogen flowrate and hydrogen flowrate within a desired range when a flowrate through the syngas compressor changes.

11. The system of claim 1, wherein the hydrogen source comprises an electrolyzer.

12. The system of claim 11, wherein the electrolyzer is electrically coupled to an energy converting facility adapted to convert energy from a renewable energy resource to electric energy.

13. The system of claim 1, wherein the nitrogen source is adapted to separate nitrogen from air.

14. A method for producing ammonia from hydrogen and nitrogen, the method comprising the following steps:
delivering a nitrogen flow at a syngas suction pressure to a suction side of a syngas compressor;
delivering a hydrogen flow at a hydrogen inlet pressure, lower than the syngas suction pressure, to a suction side of a hydrogen compression unit;
boosting the pressure of the hydrogen flow from the hydrogen inlet pressure to the syngas suction pressure in the hydrogen compression unit and delivering the compressed hydrogen to the syngas compressor;
delivering pressurized syngas from the syngas compressor to an ammonia synthesis module and produce ammonia from the compressed syngas; and
wherein the method further comprises the step of adding nitrogen to the hydrogen in the hydrogen compression unit.

15. The method of claim 14, further comprising the steps of:
delivering a main nitrogen flow at the syngas pressure from a nitrogen source;
diverting a nitrogen secondary flow from the main nitrogen flow;
reducing pressure of the nitrogen secondary flow to a reduced nitrogen pressure; and
delivering the nitrogen secondary flow at the reduced nitrogen pressure to the hydrogen compression unit.

16. The method of claim 15, wherein the step of reducing pressure of the nitrogen secondary flow includes the step of flowing the nitrogen secondary flow through a throttling valve.

17. The method of claim 15, wherein the step of reducing pressure of the nitrogen secondary flow includes the step of expanding the nitrogen secondary flow in an expander and producing useful power with the expander.

18. The method of claim 17, further comprising at least one of the following steps:
converting power generated by the expander in electric power;
transferring mechanical power generated by the expander to at least one of: the hydrogen compression unit, an air compressor, and the syngas compressor.

19. The method of claim 14, wherein the hydrogen compression unit comprises a first hydrogen compressor and a second hydrogen compressor arranged in series, the first hydrogen compressor being arranged upstream of the second hydrogen compressor with respect to the hydrogen flow in the hydrogen compression unit; and wherein nitrogen is added to the hydrogen in the hydrogen compression unit upstream of the first hydrogen compressor.

20. The method of claim 14, wherein the hydrogen compression unit comprises a first hydrogen compressor and a second hydrogen compressor arranged in series, the first hydrogen compressor being arranged upstream of the second hydrogen compressor with respect to the hydrogen flow in the hydrogen compression unit; and wherein nitrogen is added to the hydrogen between a delivery side of the first hydrogen compressor and a suction side of the second hydrogen compressor.
